(19) United States
(12) Patent Application Publication
(10) Pub. No.: US 2021/0024009 A1
(43) Pub. Date: Jan. 28, 2021

(54) MULTIFUNCTIONAL RAILING MODULE ON THE SCREED FOOTWAY

(71) Applicant: JOSEPH VOEGELE AG, Ludwigshafen/Rhein (DE)

(72) Inventors: Martin BUSCHMANN, Neustadt (DE); Ralf WEISER, Ladenburg (DE); Tom GLOECKNER, Bockenheim (DE); Maximilian THEOBALD, Ludwigshafen (DE)

(73) Assignee: JOSEPH VOEGELE AG, Ludwigshafen/Rhein (DE)

(21) Appl. No.: 16/937,867

(22) Filed: Jul. 24, 2020

(30) Foreign Application Priority Data
Jul. 24, 2019 (DE) 202019104082.3

(51) Int. Cl. B60R 11/02; E01C 19/48

(52) U.S. Cl. CPC B60R 11/0264; B60K 35/00; E01C 19/48

(57) ABSTRACT

The present disclosure refers to a road finisher with a tractor, which has a paving screed coupled to the tractor by means of pulling arms and aligned transversely to the direction of travel, a screed footway being provided at the rear end of the paving screed, at least one railing module being attached to the screed footway, at least one stowing device for receiving objects being attached to the railing module.

### CROSS-REFERENCE TO RELATED APPLICATIONS

This application claims foreign priority benefits under 35 U.S.C. § 119(a)-(d) to German patent application number DE 202019104082.3, filed Jul. 24, 2019, which is incorporated by reference in its entirety.

### TECHNICAL FIELD

The present disclosure refers to a road finisher with a paving screed and a screed footway.

### BACKGROUND

It is well known that a road finisher has a movably mounted paving screed for producing a new road surface. The paving material is transported from a material bunker by means of a longitudinal conveyor against a paving direction to the rear to a paving screed movably mounted on the road finisher. The paving material is spread out in front of the paving screed and compacted by the paving screed to produce the new road surface, which is done at high temperatures. During this construction operation, the screed operator often has to move from one side of the road finisher to the other for instance in order to adjust paving parameters or other settings. The screed operator may wish to pick up tools deposited on the paver operator platform or on the cover of the paving screed such as shovels, spirit levels etc. To make this possible, a screed footway is typically provided at the rear end of the paving screed. This is known from EP 3 067 774 A1, for example.

### SUMMARY

An object of the disclosure is to improve road finishers in a user-friendly manner.

This object is solved by a road finisher according to the disclosure. Further advantageous embodiments are set forth in the disclosure.

The road finisher according to the disclosure includes a tractor, which has a paving screed coupled to the tractor by means of pulling arms and aligned transversely to the direction of travel, wherein a screed footway is provided at the rear end of the paving screed, at least one railing module is attached to the screed footway, and at least one stowage device for receiving objects is attached to the railing module, e.g., for receiving tools of various shapes and sizes for asphalt paving as well as personal objects for screed operators.

This creates stowage space for screed operators without restricting or occupying the space on the footway, while leaving the footway freely accessible. In addition, the railing module makes it easier for the operator to climb onto the paving screed and can provide support there, even when the paving screed is in a raised position.

In a variant, the railing module is attached to a part of the footway that is vibration-decoupled from the rest of the paving screed. This reduces vibrations and the resulting noise and the risk of losing objects.

It is particularly advantageous if the railing module is attached detachably, in particular detachable without the use of tools, to the screed footway. This simplifies the assembly and disassembly of the railing module construction.

In a space-saving variant, the railing module is hinged to the screed footway so that the entire structure can easily be completely dismantled.

In an advantageous variant, the railing module can be attached at different positions on the screed footway. This allows the position of the railing module and the stowage devices mounted on it to be adjusted individually.

It is useful if the railing module has at least one footway extension. This extension of the footway offers the operator additional space for standing or for placing objects. The footway extension ensures that no objects or tools protrude onto the footway itself and block it or reduce its accessibility.

The railing module may have at least one holder, which allows the attachment and accommodation of various tools, especially small tools and personal belongings of the screed operator.

The holder can be attached detachably, in particular detachable without the use of tools, to the railing module, which simplifies the assembly and conversion of the support at the railing module.

In another design variant, the railing module has at least one perforated plate, which allows variable attachment and accommodation of various tools, especially hanging tools, as well as personal belongings of the screed operators. The perforated plate could also be fitted with one or more holders to hold objects. The perforated plate guarantees individual adaptation for the accommodation of tools and personal belongings.

The perforated plate can be attached detachably, in particular detachable without the use of tools, to the railing module, which simplifies the assembly and conversion of the perforated plate on the railing module.

In another advantageous design variant, the railing module has a toolbox which allows the placement and accommodation of small and large tools, especially small tools with a length of up to approx. 50 cm, as well as personal belongings of the screed operators.

It is particularly advantageous if the toolbox can be attached detachably, in particular detachable without the use of tools, at the railing module, which simplifies the assembly and conversion of the toolbox at the railing module.

### BRIEF DESCRIPTION OF THE DRAWINGS

In the following, embodiments of the disclosure are described in more detail using the Figures.

FIG. 1 shows a road finisher for producing a road surface, including a paving screed attached to it;

FIG. 2 shows a perspective front view of a railing module with stowage devices from an oblique front view, attached to the screed footway; and

FIG. 3 shows a perspective view of the railing module of FIG. 2 from an oblique rear view.

### DETAILED DESCRIPTION

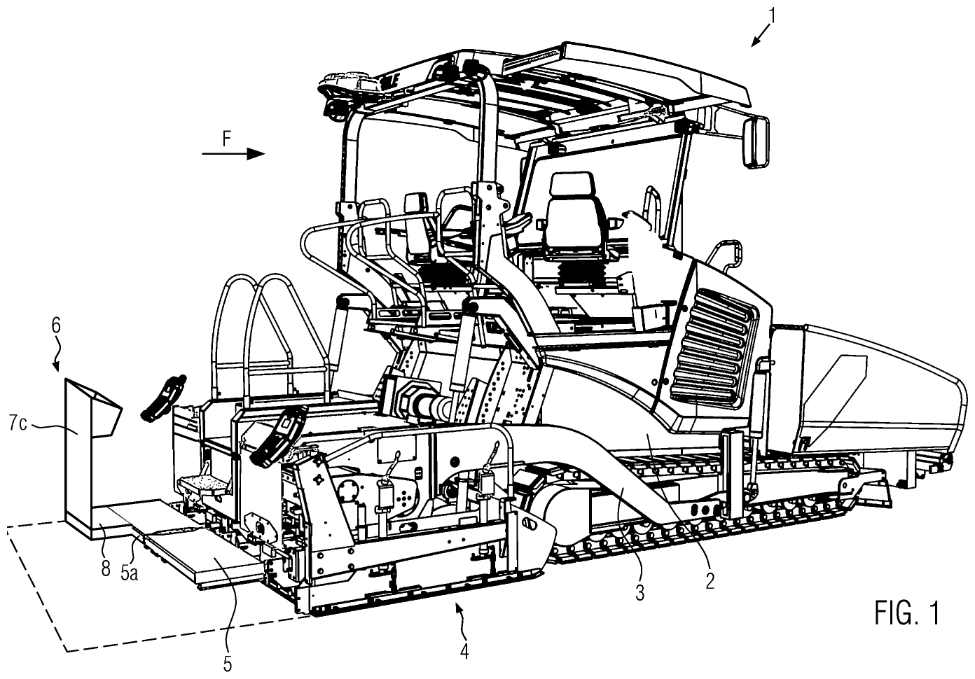

FIG. 1 shows a road finisher 1 for producing a road surface. The road finisher 1 comprises a tractor 2 and a paving screed 4. The paving screed 4 is coupled to the tractor 2 by means of pulling arms 3 and is towed by the tractor 2 in the direction of travel F when the road finisher 1 is in operation. The paving material is spread out in front of the paving screed 4 and compacted by the paving screed 4 to produce the new road surface. At the rear end of the paving screed 4, a screed footway 5 is provided as a kind of bridge, allowing the screed operators to walk across the paving material in transverse direction without having to step on the still hot new road surface.

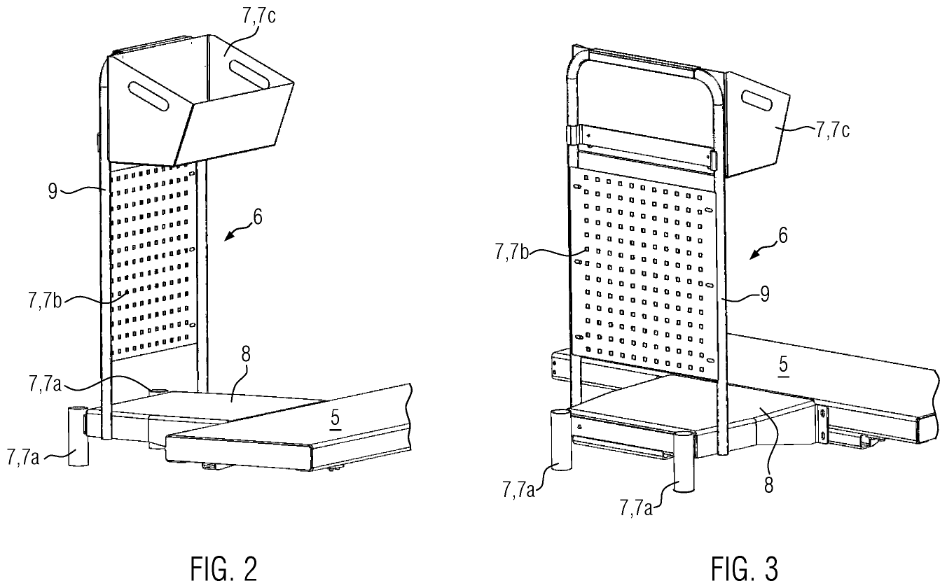

FIG. 2 shows the screed footway 5 according to the disclosure from an oblique front view, to which a railing module 6 is attached.

FIG. 3 shows the screed footway 5 according to the disclosure from an oblique rear view, to which a railing module 6 is attached.

The construction of the railing module 6 can be easily dismantled in its entirety. The railing module 6 can be positioned at different points on the screed footway 5. Connecting fittings can be used to attach the railing module 6.

The railing module 6 shown as an example in FIG. 2 and FIG. 3 has a footway extension 8, which extends the footway to the rear as seen in the direction of travel. The footway extension 8 can be designed to support the weight of one or more operators and also the weight of the tools used during the construction of a road surface.

In addition, the footway extension 8 could be installed at one of the end areas of the screed footway 5 as an extension in direction of travel F.

The footway extension 8 can have several telescopic rail-like extension elements, thus extending the footway extension 8 along its length in direction of travel F. Furthermore, the construction elements of the footway extension 8 can be designed to fold onto the screed footway 5.

The railing module 6 shown as an example in FIG. 2 and FIG. 3 may have one or more stowage devices 7 for holding objects, for example in the form of a holder 7a.

Holders 7a of different size and shape can be arranged detachably, particularly detachable without the use of tools, on the railing module 6, for example at the rear end of the footway extension 8 opposite the attachment point of the footway extension 8 on the screed footway 5, for the attachment of e.g., large and objects with a stem. It is also possible to arrange the holders 7a at another position on the railing module 6. The holders 7a may, for example, be in the form of a bracket which is particularly suitable for receiving a shovel blade, the form of a tubular sleeve closed at the bottom or a cup which is designed in such a way that it could receive a broomstick or shovel stick. The holder 7a may be provided with a lockable cover.

Another form of stowage device 7 for receiving objects, which is arranged on the railing module 6, may be a perforated plate 7b, especially for stowage objects that can be hung up. The railing module 6 also has several interlocking rods 9 which form the load-bearing structure and on which the perforated plate 7b is placed.

The perforated plate 7b can be designed double-walled, so that long tools such as brooms can also be placed in the holes.

The perforated plate 7b can be of various sizes and shapes and can be attached to the rear end of the footway extension 8 opposite the attachment point of the footway extension 8 on the screed footway 5 in a detachable manner, in particular detachable without the use of tools. It is also possible to arrange the perforated plate 7b at another position on the railing module 6.

Another form of a stowage device 7 for receiving objects placed on the railing module 6 may be a toolbox 7c, especially for stowage objects that do not fit into the holder 7a or that cannot be hung on the perforated plate 7b.

The toolbox 7c can be of different sizes and shapes and can be located, for example, at the top of railing module 6 on rods 9, as shown in FIG. 2 and FIG. 3. It is also possible to place the toolbox 7c in other positions on the railing module 6. The toolbox 7c can be closed with a lockable lid to protect it from rain or theft.

What is claimed is:

1. A road finisher with a tractor, which has a paving screed coupled to the tractor by means of pulling arms and aligned transversely to the direction of travel, wherein a screed footway being provided at the rear end of the paving screed, wherein at least one railing module is attached to the screed footway, and at least one stowage device for receiving objects is attached to the railing module.

2. The road finisher according to claim 1, wherein the railing module is detachably attached to the screed footway.

3. The road finisher according to claim 1, wherein the railing module is detachably attached without the use of tools to the screed footway.

4. The road finisher according to claim 1, wherein the railing module together with the screed footway is hingedly attached to the paving screed.

5. The road finisher according to claim 1, wherein the railing module is attached to a vibration-decoupled part of the screed footway.

6. The road finisher according to claim 1, wherein the railing module is attachable to the screed footway at different positions.

7. The road finisher according to claim 1, wherein the railing module comprises at least one footway extension.

8. The road finisher according to claim 1, wherein the railing module comprises at least one holder.

9. The road finisher according to claim 8, wherein the holder can be detachably attached to the railing module.

10. The road finisher according to claim 8, wherein the holder can be detachably attached without the use of tools to the railing module.

11. The road finisher according to claim 1, wherein the railing module comprises at least one perforated plate.

12. The road finisher according to claim 11, wherein the perforated plate is detachably attached to the railing module.

13. The road finisher according to claim 11, wherein the perforated plate is detachably attached to the railing module without the use of tools.

14. The road finisher according to claim 1, wherein the railing module comprises a toolbox.

15. The road finisher according to claim 14, wherein the toolbox is detachably attached to the railing module.

16. The road finisher according to claim 14, wherein the toolbox is detachably attached to the railing module without the use of tools.

17. A road finisher comprising:
a tractor;
a paving screed coupled to the tractor by means of pulling arms and aligned transversely to the direction of travel, the paving screed having a rear end;
a screed footway coupled to the rear end of the paving screed;
a railing module attached to the screed footway; and
a stowage device for receiving objects attached to the railing module.

18. The road finisher according to claim 17, wherein the railing module is detachably attached to the screed footway.

19. The road finisher according to claim 17, wherein the railing module is attachable to the screed footway at different positions.

20. The road finisher according to claim 17, wherein the railing module comprises at least one footway extension.
